(19) United States
(12) Patent Application Publication
(10) Pub. No.: US 2025/0200390 A1
(43) Pub. Date: Jun. 19, 2025

(54) MANAGEMENT AND STORAGE OF NEURAL NETWORK WEIGHTS

(71) Applicant: Sandisk Technologies, Inc., Milpitas, CA (US)

(72) Inventors: Ramanathan Muthiah, Bangalore (IN); Alexander Bazarsky, Holon (IL); Ariel Navon, Revava (IL); Eran Sharon, Rishon Lezion (IL)

(73) Assignee: Sandisk Technologies, Inc., Milpitas, CA (US)

(21) Appl. No.: 18/538,890

(22) Filed: Dec. 13, 2023

(51) Int. Cl. G06N 3/10

(52) U.S. Cl. CPC G06N 3/10

(57) ABSTRACT

A Data Storage Device (DSD) receives weights for a plurality of layers of a neural network with layer information associating the weights with one or more layers. The received weights are stored in at least one Non-Volatile Memory (NVM) of the DSD using different storage characteristics based at least in part on the received layer information. The different storage characteristics include at least one of different storage locations, different storage techniques, and different storage maintenance settings. In another aspect, a first group of weights is requested by a host device for processing one or more first layers. The first group of weights is received by the host device and loaded into at least one memory of the host device. A second group of weights is requested from the DSD for processing one or more additional layers of the neural network before computations complete for the one or more first layers.

### BACKGROUND

Neural networks are a type of machine learning that uses interconnected nodes or neurons that are arranged in layers to make inferences about inputs to the neural network. The sizes of neural networks have been generally increasing in terms of the number of layers and nodes. The data being fed into each node is usually weighted to represent the importance of the data in computations performed by the node.

As the number of connections grows between nodes in a neural network, the number of weights for the different layers of the neural network also grows. Once a neural network is trained, the weights are typically stored in a data structure or file format that allows the weights to be stored in a non-volatile storage and loaded into a memory for processing data by the nodes. Loading the weights into the memory can often take a significant amount of time that delays processing by the neural network. Moreover, there is a need to store and access weights for neural networks more efficiently.

### BRIEF DESCRIPTION OF THE DRAWINGS

The features and advantages of the embodiments of the present disclosure will become more apparent from the detailed description set forth below when taken in conjunction with the drawings. The drawings and the associated descriptions are provided to illustrate embodiments of the disclosure and not to limit the scope of what is claimed.

FIG. 1 is a block diagram of an example system for managing and storing neural network weights according to one or more embodiments.

FIG. 2A is an example mapping table according to one or more embodiments.

FIG. 2B is an example Key-Value Store (KVS) according to one or more embodiments.

FIG. 3 illustrates the interleaving of dies of a solid-state memory for storing neural network weights according to one or more embodiments.

FIG. 4 is a flowchart for a weight storage process according to one or more embodiments.

FIG. 5 is a flowchart for a weight retrieval process according to one or more embodiments.

FIG. 6 is a flowchart for a batched weight access process according to one or more embodiments.

FIG. 7 is a flowchart for a weight storage process according to one or more embodiments.

FIG. 8 is a flowchart for a weight modification process according to one or more embodiments.

### DETAILED DESCRIPTION

In the following detailed description, numerous specific details are set forth to provide a full understanding of the present disclosure. It will be apparent, however, to one of ordinary skill in the art that the various embodiments disclosed may be practiced without some of these specific details. In other instances, well-known structures and techniques have not been shown in detail to avoid unnecessarily obscuring the various embodiments.

### Example System Environments

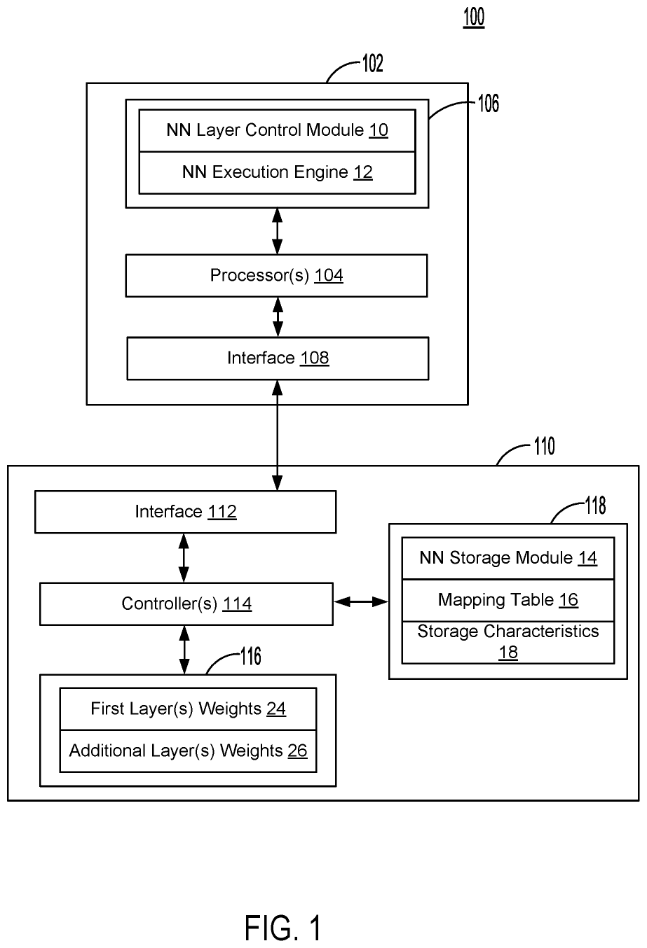

FIG. 1 is a block diagram of an example system 100 for managing and storing neural network weights according to one or more embodiments. As shown in FIG. 1, system 100 includes host device 102 and Data Storage Device (DSD) 110. In some implementations, host device 102 and DSD 110 can form, for example, a computer system, such as a desktop, laptop, or client and server. In this regard, host device 102 and DSD 110 may be housed separately, such as where host device 102 may be a client accessing DSD 110 as a server. In other implementations, host device 102 and DSD 110 may be housed together as part of a single electronic device. In other implementations, host device 102 and DSD 110 may not be co-located and may be in different geographical locations.

Host device 102 includes one or more processors 104, interface 108, and one or more local memories 106. Processor(s) 104 can include, for example, circuitry such as one or more Central Processing Units (CPUs), Graphics Processing Units (GPUs), microcontrollers, Digital Signal Processors (DSPs), Application-Specific Integrated Circuits (ASICs), Field Programmable Gate Arrays (FPGAs), hard-wired logic, analog circuitry and/or a combination thereof. In some implementations, processor(s) 104 can include a System on a Chip (SoC) that may be combined with one or more memories 106 of host device 102 and/or interface 108. In the example of FIG. 1, processor(s) 104 execute instructions, such as instructions from Neural Network (NN) layer control module 10 and NN execution engine 12.

Host device 102 can communicate with DSD 110 using interface 108 via a bus or network, which can include, for example, a Compute Express Link (CXL) bus, Peripheral Component Interconnect express (PCIe) bus, a Network on a Chip (NoC), a Local Area Network (LAN), or a Wide Area Network (WAN), such as the internet or another type of bus or network. In this regard, interface 108 can include a network interface card in some implementations. In some examples, host device 102 can include software for controlling communication with DSD 110, such as a device driver of an operating system of host device 102.

As shown in the example of FIG. 1, host device 102 includes its own local memory or memories 106, which can include, for example, a Dynamic Random Access Memory (DRAM), Static Random Access Memory (SRAM), Magnetoresistive RAM (MRAM) or other type of Storage Class Memory (SCM), or other type of solid-state memory.

While the description herein refers to solid-state memory generally, it is understood that solid-state memory may comprise one or more of various types of memory devices such as flash integrated circuits, NAND memory (e.g., Single-Level Cell (SLC) memory, Multi-Level Cell (MLC) memory (i.e., two or more levels), or any combination thereof), NOR memory, EEPROM, Chalcogenide RAM (C-RAM), Phase Change Memory (PCM), Programmable Metallization Cell RAM (PMC-RAM or PMCm), Ovonic Unified Memory (OUM), Resistive RAM (RRAM), Ferroelectric Memory (FeRAM), MRAM, 3D-XPoint memory, and/or other discrete Non-Volatile Memory (NVM) chips, or any combination thereof.

In the example of FIG. 1, memory or memories 106 of host device 102 store NN layer control module 10 and NN execution engine 12. In this regard, NN layer control module 10 and NN execution engine 12 can include computer-executable instructions or modules and/or data used by such computer-executable instructions or modules.

As discussed in more detail below, NN layer control module 10 can retrieve weights from DSD 110 to load into memory or memories 106 of host device 102. In some implementations, NN layer control module 10 can request the weights for a neural network executed by NN execution engine 12 for one layer of the neural network at a time to reduce a latency in loading the weights, as compared to loading all of the neural network weights into memory at the same time as is typically done with neural networks. In other implementations, weights for one or more layers less than the full number of layers can be loaded in batches or groups based on a size or number of weights for the one or more layers to better balance the latency in retrieving weights from DSD 110 over a period of time while the neural network processes data for earlier layers.

For example, NN layer control module 10 may request a first group of weights from DSD 110 for processing inputs to the neural network by NN execution engine 12 in a first layer of nodes. NN execution engine 12 may initiate computations of the first layer and NN layer control module 10 can request a second group of weights from DSD 110 for processing one or more additional layers before computations complete for the first layer of the neural network. In this regard, NN layer control module 10 may monitor the progress of the processing being performed by NN execution engine 12 in some implementations or may receive an indication when a first layer of computations has completed or is nearing completion, which may trigger the request from NN layer control module 10 for the next group of weights for one or more additional layers.

In other implementations, host device 102 may only be responsible for computing a portion of the total layers of the neural network. In such implementations, a “first layer” or “one or more first layers” as used herein can refer to the first layer or first set of layers to be processed by host device 102, which may or may not include an initial input layer of the neural network.

As shown in the example of FIG. 1, DSD 110 includes interface 112, one or more controllers 114, one or more NVMs 116, and one or more memory or memories 118. In some implementations, DSD 110 can include, for example, a Solid-State Drive (SSD) that includes solid-state storage media, a Hard Disk Drive (HDD) that includes rotating magnetic disk storage media, or a Solid-State Hybrid Drive (SSHD) that includes both solid-state media and rotating magnetic disk media for data storage.

Interface 112 of DSD 110 can communicate with host device 102 using interface 112 via a bus or network, which can include, for example, a CXL bus, PCIe bus, an NoC, a LAN, or a WAN, such as the internet or another type of bus or network. In this regard, interface 112 may include a network interface card in some implementations.

Controller(s) 114 can include, for example, circuitry such as one or more CPUs or other type of processors, microcontrollers, DSPs, ASICs, FPGAs, hard-wired logic, analog circuitry and/or a combination thereof that controls operation of DSD 110. In some implementations, a controller 114 can include an SoC that may be combined with one or more memories of DSD 110 and/or interface 112.

NVM(s) 116 can include one or more memory devices, such as solid-state memory devices and/or hard disk devices for non-volatilely storing weights for the neural network executed by host device 102. As shown in the example of FIG. 1, NVM(s) 116 store first layer(s) weights 24 and additional layer(s) weights 26. Those of ordinary skill in the art will appreciate with reference to the present disclosure that NVM(s) 116 may store weights and other values for numerous layers of the neural network executed by host device 102 that may not be depicted in FIG. 1 for purposes of illustration.

In some implementations, first layer(s) weights 24 and additional layer(s) weights 26 can be non-volatilely stored in different types of storage media with first layer(s) weights 24 being stored in a first type of storage media that has a lower read latency so that host device 102 can retrieve first layer(s) weights 24 faster than additional layer(s) weights 26 stored in a second type of storage media. In such implementations, this may enable a more efficient storage of the weights since additional layer(s) weights 26 can be retrieved while computations have already begun for the neural network and may have more time before the weights are needed by host device 102. The first type of storage media can include, for example, using a solid-state memory media for non-volatilely storing first layer(s) weights 24 and using a rotating magnetic disk media for non-volatilely storing additional layer(s) weights 26 so that first layer(s) weights 24 can be retrieved faster from NVM(s) 116 than additional layer(s) weights 26.

The second type of storage media used for storing additional layer(s) weights 26 in some implementations may provide a less expensive and/or higher data density storage media at a cost of slower data access performance. As used herein, data density can refer to the amount of data that can be stored in a given physical area of the storage media. In such an example, rotating magnetic disks may be used as a second type of storage media for storing additional layer(s) weights 26 that may have a greater data access latency than a solid-state memory used as a first type of storage media for storing first layer(s) weights 24, but the second type of storage media may provide a higher storage density using technologies, such as Shingled Magnetic Recording (SMR), for example. As another example, the first type of storage media storing first layer(s) weights 24 can include a more expensive SCM, such as MRAM, while the second type of storage media storing additional layer(s) weights 26 can include a less expensive flash memory.

In some implementations, the same storage media may be used to store both first layer(s) weights 24 and additional layer(s) weights 26, but the storage of first layer(s) weights 24 and additional layer(s) weights 26 may be performed differently using different storage techniques, such as by programming more bits per cell of solid-state memory to store additional layer(s) weights 26 than for storing additional layer(s) weights 26. In such an example, the use of the different storage techniques can result in different types of storage media by storing first layer(s) weights 24 in SLC memory and storing additional layer(s) weights 26 in MLC memory, which provides a higher data storage density by storing more bits per cell at a cost of slower programming times for writing data and slower read times to read data since data may need to be written to and read from the MLC memory using a higher resolution.

In some cases, the different storage techniques for storing first layer(s) weights 24 and additional layer(s) weights 26 can include using different data sizes for each weight, such as storing additional bits for the values of additional layer(s) weights 26 than for first layer(s) weights 24 or vice versa. In such cases, this can provide a higher accuracy for particular layers of the neural network at a greater storage cost in terms of storage capacity. In some implementations, the value type for each weight of one or more layers can include binary values that may reduce the storage capacity of the weights, while other layers may use floating point values that provide a more accurate weighting but require a greater storage capacity in NVM(s) 116 to store each weight of such layers.

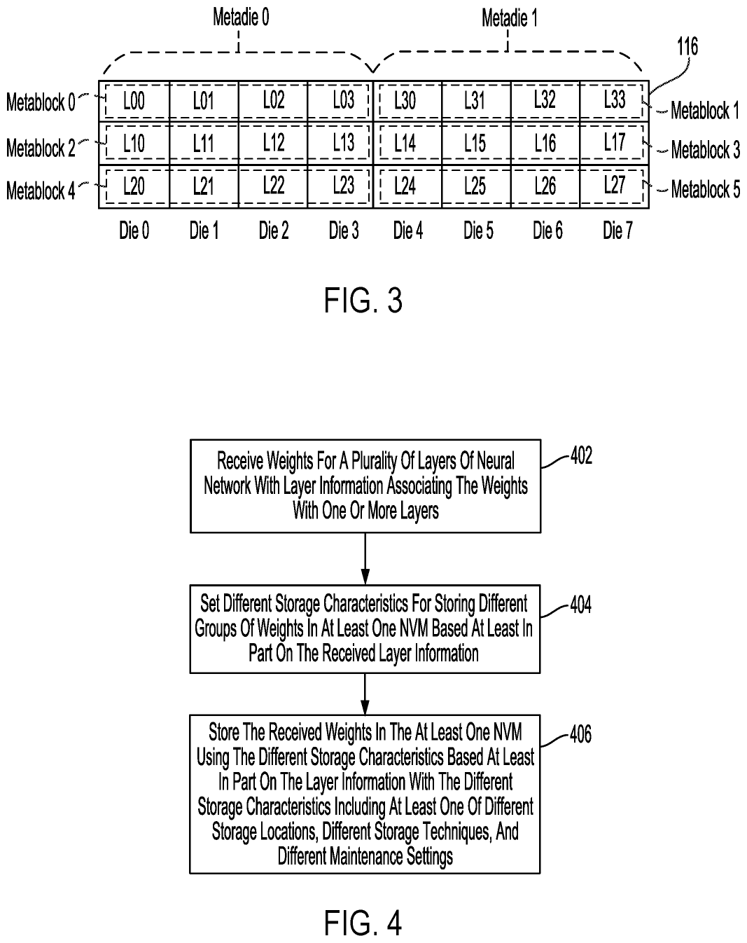

Another example of using different storage techniques for storing first layer(s) weights 24 and additional layer(s) weights 26 can include using a different number of physical dies of solid-state memory for a given data size or varying an amount of data stored at each physical die in a logical “metadie” based on the layer of the weights. As discussed in more detail below with reference to FIG. 3, storing the weights for one or more layers across multiple physical dies that form a logical metadie can decrease the latency in retrieving the weights since the multiple dies can be accessed at the same time. In such an example, first layer(s) weights 24 may be stored across multiple dies, the number of which may depend on the storage size of first layer(s) weights 24, while additional layer(s) weights 26 may be stored in a single die or in a lesser number of dies per storage size of the weights.

As another example of varying a storage technique for different layers of weights, some implementations may use different amounts of parity data for first layer(s) weights 24 and for additional layer(s) weights 26 for a given amount of data consumed by the weights. A greater amount of parity data for a given data size can provide greater error correcting capability, which may be used to correct bit errors when reading data from NVM(s) 116 by using an Error Correction Code (ECC), for example. In some implementations, weights from layers that are less likely to be modified (e.g., weights for earlier layers) can be written with more parity data since such weights are more likely to be stored longer in NVM(s) 116 and may be more susceptible to bit errors during reading than weights for layers that have been recently rewritten due to modification.

The identification of weights by layer in NVM(s) 116 can enable the modification of weights for particular layers of the neural network without modifying the weights for other layers. This can provide an improvement over the conventional storage of neural network weights in a single file or in a data structure that does not identify the weights by layer. In some cases, later layers that are closer to an output layer of the neural network may be more likely to be modified than earlier layers or a “backbone” of the neural network. The amount of parity data for the weights of different layers may vary based on the storage density or reliability of the storage medium used to store the weights such that more parity data for a given data size is used to store weights in less reliable storage media to improve the correction capability of the data.

In this regard, a slower reading technique may be used in some implementations to increase reliability (e.g., multi-soft bit slow reading) and/or a slower writing technique may be used to reduce noise (e.g., smaller programmable voltage step sizes) to compensate for less reliable storage media or a higher data density that may be more prone to errors. In some implementations, DSD 110 may vary the maintenance settings for retaining weights in NVM(s) 116 based on the layer using the weights. For example, less power may be used for retaining weights in NVM(s) 116 for layers that are more likely to be modified. In another example, a read threshold may be calibrated less often for portions of NVM(s) 116 that store weights for layers that are more likely to be modified. As another example, the weights for layers that are more likely to be modified may be refreshed or rewritten less often to conserve resources of DSD 110.

In the example of FIG. 1, memory or memories 118 of DSD 110 can include, for example, a DRAM, SRAM, MRAM, or other type of solid-state memory. As shown in FIG. 1, memory or memories 118 store NN storage module 14, mapping table 16, and storage characteristics 18. In this regard, memory or memories 118 can store computer-executable instructions or modules, such as NN storage module 14, and data used by such computer-executable instructions or modules, such as mapping table 16 and storage characteristics 18. In some implementations, memory or memories 118 can also temporarily store or buffer data that is received from host device 102 and/or data to be sent to host device 102.

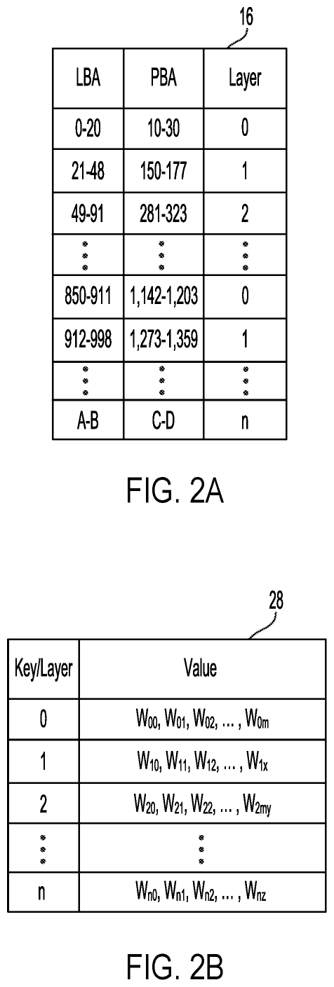

NN storage module 14 can be executed by one or more controllers 114 to control the storage location, storage techniques, and/or maintenance settings for storing weights in NVM(s) 116 based on the layer or layers of the neural network associated with the weights. In some implementations, the indication of which layers use the weights can be included in mapping table 16, which associates logical identifiers (e.g., Logical Block Addresses (LBAs)) for the weights that are used by host device 102 with physical storage location identifiers (e.g., Physical Block Addresses (PBAs)) indicating the storage locations for the weights in NVM(s) 116. An example of mapping table 16 is provided in FIG. 2A, which is discussed in more detail below. In other implementations, DSD 110 may instead use a Key-Value Store (KVS) or other type of data structure for associating the weights with the layers that use the weights. An example of a KVS is provided in FIG. 2B, which is discussed in more detail below.

Storage characteristics 18 stored in memory or memories 118 in FIG. 1 can include settings used by NN storage module 14 for storing and retaining weights of the neural network, such as storage locations for different layers, storage techniques for different layers (e.g., an amount of parity data for storing a predetermined amount of data of different layers, a programming or write speed in storing the weights of different layers, a number of dies or metadies to use in storing weights of different layers, threshold metablock sizes for different layers, a number of levels or bits to store per cell for weights of different layers, and/or a data size or value type for each weight of a particular layer), and/or maintenance settings for different layers (e.g., different power levels for different layers, different frequencies of read threshold calibration for different layers, and/or different frequencies of rewriting data for different layers). In some implementations, storage characteristics 18 may specify different priorities for different layers that correspond to different storage locations, storage techniques, and/or maintenance settings.

Those of ordinary skill in the art will appreciate with reference to the present disclosure that other implementations of system 100 may differ. For example, NN layer control module 10 and NN execution engine 12 may be combined in some implementations. As another example variation, other implementations may include multiple host devices 102 and/or multiple DSDs 110 for executing a neural network and storing its associated weights and values. In such implementations, different host devices 102 and/or DSDs 110 may be responsible for executing or storing different layers or groups of layers of the neural network. As yet another example variation, other implementations of DSD 110 may include many more groups of layers of weights stored in NVM(s) 116 than first layer(s) weights 24 and additional layer(s) weights 26. As yet another example variation, other implementations may instead use a KVS for storing first layer(s) weights 24 and additional layer(s) weights 26 and may not include mapping table 16.

FIG. 2A illustrates an example mapping table 16 according to one or more embodiments. As shown in the example of FIG. 2A, mapping table 16 provides a logical to physical mapping that associates logical identifiers (i.e., LBAs) for weights with physical storage locations (i.e., PBAs) in NVM(s) 116 that store the weights. Mapping table 16 also includes an indication of the layer of the weights as layer information. In some implementations, a controller 114 executing NN storage module 14 may use the indication in mapping table 16 to retrieve the weights for one or more layers of the neural network to provide to host device 102 in stages or batches or to provide to a device for retraining the neural network.

In this regard, the indication of layers in mapping table 16 or in another data structure maintained by DSD 110 can be used by other host devices or servers that may need access to the weights of particular layers without knowing the LBAs used by host device 102 for the weights of different layers. This can be useful for cases where a different device may need to access the weights of particular layers, such as to retrain the neural network or to implement the neural network on a different device when host device 102 is unavailable.

In the example of FIG. 2A, the weights for the different layers are interleaved or interspersed in terms of physical storage locations as indicated by the non-sequential ranges of PBAs for the layers. For example, layer 0 has PBAs 10-30 and 1,142-1,203 in mapping table 16. This may be due to storing the weights for layer 0 in different physical dies in NVM(s) 116 or in otherwise discontinuous physical storage locations. In other implementations, the LBAs may be continuous ranges for a given layer (e.g., LBAs 0-100 for layer 0) while the PBAs may be discontinuous for the layer (e.g., PBAs 0-50 and 101-150). In addition, there may be a greater number of PBAs than LBAs in some implementations for a given layer due to defects in the storage media causing certain PBAs to be mapped out.

Those of ordinary skill in the art will appreciate with reference to the present disclosure that other implementations of mapping table 16 may differ. For example, the ranges of LBAs and/or PBAs may be contiguous for each layer, rather than disjointed as in the example of FIG. 2A. In other examples, a separate data structure maintained by DSD 110 may be used to associate the layers with logical identifiers or physical storage locations for the weights of the layer.

FIG. 2B is an example of KVS 28 according to one or more embodiments, which may replace mapping table 16. In the example of FIG. 2B, a layer number serves as a key for accessing the weights stored in KVS 28 with layers 0 to n serving as keys. As shown in FIG. 2B, the weights for a particular layer, such as layer 0 are stored in KVS 28 as W₀₀, W₀₁, W₀₂, . . . , W₀ₘ. In some implementations, KVS 28 may be stored in NVM(s) 116 and accessed by controller(s) 114 to provide the weights stored as values for a particular layer or group of layers to host device 102. The sizes and number of weights stored for each layer in KVS 28 can vary. In some implementations, host device 102 may request the weights for a layer by providing the layer number or the key to DSD 110.

Those of ordinary skill in the art will appreciate with reference to the present disclosure that other implementations of KVS 28 may differ. For example, the keys may be generated by a hashing algorithm that may use the layer number as input, rather than directly identifying the layer number as the key. In such examples, KVS 28 may include an additional field to identify a layer number or may use a separate data structure associating the key values with their associated layers.

FIG. 3 illustrates the interleaving of dies for storing neural network weights according to one or more embodiments. As shown in FIG. 3, eight physical dies of a solid-state memory of NVM(s) 116 are arranged into two logical metadies. Dies 0 to 3 form metadie 0 and dies 4 to 7 form metadie 1. Portions of the group of weights for each layer are stored across multiple physical dies to decrease the read latency for retrieving the weights. In more detail, storing the weights for a layer across a greater number of physical dies can reduce the retrieval time for the weights by putting a greater number of backend resources, such as dies, flash channels, and corresponding caches, to use for retrieving layer's weights from NVM(s) 116.

In addition, the number of dies or metadies used to store the weights of a layer can be determined by DSD 110 based on the size of the weights to be stored for the layer. For example, the weights for a first layer, L0 in FIG. 3, may be stored in a single metablock 0 in metadie 0, while a larger number of weights for a second layer, L1 in FIG. 3, may be stored in metablocks 2 and 3 in parallel across metadies 0 and 1 due to the larger storage size of the weights for the second layer L1.

In some implementations, weights for layers that may need to be accessed faster from DSD 110, such as a first layer, may be stored across a greater number of physical dies using a larger number of metablocks or metadies for a given data size than weights for layers that may not need to be accessed as quickly. In such cases, the amount of data stored at each die for the faster access layer may be lower than for the slower access layer to spread the data for the faster access layer across more dies. In some implementations, an amount of data to be stored at each die for the layer or a threshold data size for a metablock for the layer can be included as part of storage characteristics 18. For example, a controller 114 of DSD 110 may determine the storage size of the weights for a layer and determine a number of metablocks to be used based on a number of metablocks needed to store the weights for the layer.

Those of ordinary skill in the art will appreciate with reference to the present disclosure that other implementations of NVM(s) 116 may differ. For example, NVM(s) 116 in FIG. 3 has been shown for the purposes of illustration and can include many more physical dies, metadies, and metablocks than shown in FIG. 3. As discussed above, other implementations of NVM(s) 116 or other portions of NVM(s) 116 can use different types of non-volatile storage media, such as a rotating magnetic disk, for example.

### Example Processes

FIG. 4 is a flowchart for a weight storage process according to one or more embodiments. The process of FIG. 4 can be performed by, for example, one or more controllers 114 of DSD 110 executing NN storage module 14 in FIG. 1.

In block 402, a DSD (e.g., DSD 110 in FIG. 1) receives weights and layer information for a plurality of layers of a neural network, such as from host device 102 or from another device that may have trained the neural network to determine the weights. In some implementations, a NN layer control module of the host device or a training module of the host device, or a separate device for training the neural network, provides layer information associating the weights with one or more layers of the neural network. The host device or training device in some implementations may indicate a priority for one or more layers or for the weights for such a layer or layers as the layer information. For example, first layer(s) weights 24 in FIG. 1 may be sent to the DSD with a priority indicating that the weights have a higher priority than additional layer(s) weights 26 sent to the DSD. In other examples, the layer information may provide an indication of the layer that uses each weight provided for storage. The DSD may use a default priority for the weights of a first layer or a lowest numbered layer that is a higher priority than for weights of other layers to be stored in at least one NVM of the DSD (e.g., NVM(s) 116 in FIG. 1).

In some implementations, as part of the layer information, the host device or a training device sending the weights to the DSD may specify if certain layers are more likely to be modified than other layers, such as one or more later layers of the neural network. In other implementations, the DSD may identify weights of such one or more later layers as more likely to be modified as a default. The DSD may then adjust certain maintenance settings for weights from such layers likely to be modified as discussed above to conserve resources of the DSD.

In block 404, the one or more controllers of the DSD set different storage characteristics for storing different groups of weights in the at least one NVM based at least in part on the received layer information. The storage characteristics may be set, for example, in a data structure used by the one or more controllers, such as storage characteristics 18 in FIG. 1. As noted above, the different storage characteristics can include, for example, different types of storage media in the at least one NVM used to store the weights, or different storage techniques in storing the weights, such as an amount of parity data to store for a given amount of stored data, a programming or write speed in storing the data, a number of dies to use to store each layer of weights, a number of levels or bits to store per cell for different layers, and/or a data size or value type for each weight of a layer, such as whether the weights for a particular layer are represented with binary values or floating point values. The storage characteristics can additionally or alternatively indicate maintenance settings for the weights of the different layers, such as different power levels to retain data, a frequency for read threshold calibrations, and/or a frequency of rewriting the weights for the layer.

In some implementations, the storage characteristics may specify different priorities for the different layers that correspond to different storage locations, storage techniques, and/or maintenance settings. As discussed above, the use of different storage characteristics by the DSD for the weights of the different layers can provide different read latencies and/or costs for storing the weights in terms of power, data density, and/or expense of the storage media used to store the weights.

In block 406, the DSD stores the received weights in the at least one NVM using the different storage characteristics based at least in part on the layer information. For example, weights for one or more earlier layers (e.g., first layer(s) weights 24 in FIG. 1) can be stored in a portion of an NVM of the DSD that can be accessed quicker for reading weights than storage locations used to store weights for one or more subsequent layers (e.g., additional layer(s) weights 26 in FIG. 1). As discussed above, this can improve an overall performance of the neural network since the host device can begin processing the one or more first layers without having to wait to load the weights for all the layers into a memory of the host device (e.g., memory or memories 106 in FIG. 1).

In addition, the one or more controllers of the DSD can group the weights based on the layers of the neural network that use the weights. This grouping of weights may, for example, be set in a data structure such as a mapping table (e.g., mapping table 16 in FIG. 2A), a KVS (e.g., KVS 28 in FIG. 2B), and/or a data structure indicating different storage locations, different storage techniques, and/or different maintenance settings for the different layers (e.g., storage characteristics 18 in FIG. 1).

Those of ordinary skill in the art will appreciate with reference to the present disclosure that other implementations of the weight storage process of FIG. 4 may differ. For example, the receipt of weights in block 402 may occur in stages based on the layers for the weights. As another example variation, the setting of storage characteristics in block 404 may occur after the weights are stored in block 406 in cases where the storage characteristics for the weights of the different layers only differ in terms of maintenance settings used to retain the weights in the at least one NVM.

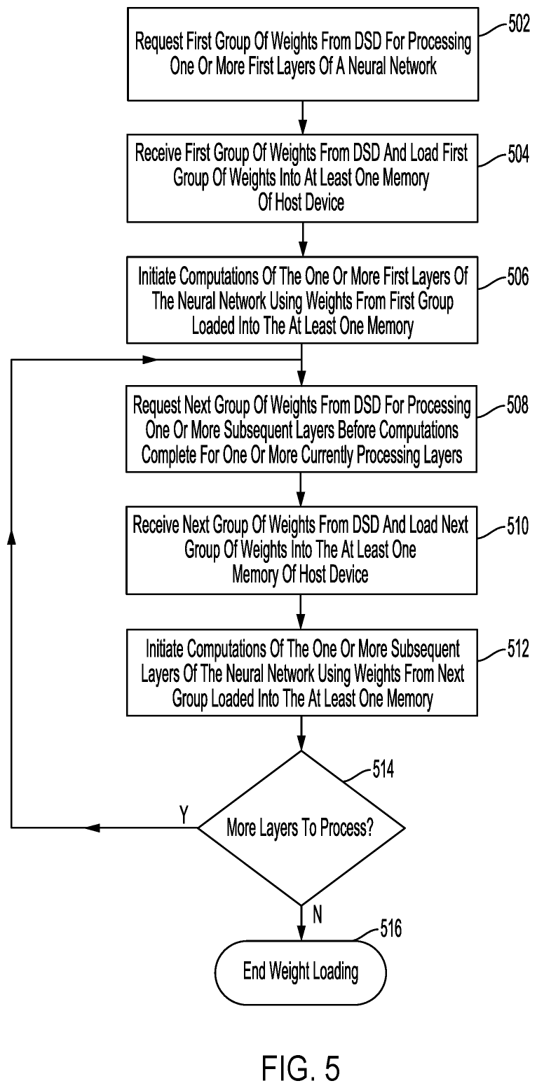

FIG. 5 is a flowchart for a weight retrieval process according to one or more embodiments. The process of FIG. 5 can be performed by, for example, one or more processors 104 of host device 102 in FIG. 1 executing NN layer control module 10 and NN execution engine 12.

In block 502, one or more processors of a host device (e.g., processor(s) 104 in FIG. 1) request a first group of weights from a DSD (e.g., DSD 110 in FIG. 1) for processing inputs to a neural network in one or more first layers of the neural network. A NN layer control module of the host device (e.g., NN layer control module 10 in FIG. 1) in some implementations may control the retrieval of weights for particular layers and may monitor the performance of the neural network computations to sequence requests for groups or batches of weights by layer or layers based on the progress of the current computations, which may be provided by a NN execution engine (e.g., NN execution engine 12). In some cases, the NN execution engine may indicate the receipt of inputs to the NN control layer module, which can trigger the request for the first group of weights in block 502. In some implementations, the request for a group of weights can be triggered by the availability of resources of the host device. For example, a NN layer control module may request a group of weights in response to the availability of a memory and/or processing resource, such as a cache, for loading or processing weights of the neural network.

In block 504, the host device receives the first group of weights from the DSD. The first group of weights is loaded into at least one memory of the host device (e.g., memory or memories 106 in FIG. 1). The weights of the first group can then be accessed by the NN execution engine from the at least one memory to perform computations for the one or more first layers of the neural network.

In block 506, the one or more processors of the host device initiate computations of the one or more first layers of the neural network using weights from the first group loaded into the at least one memory. During the computations, the one or more processors can access the weights loaded or stored in the at least one memory of the host device and invalidate the data or release the memory storing the weights for a layer after completing the processing for the layer to free up memory in the host device. In some implementations, the NN layer control module may monitor the freeing of the at least one memory in tracking the progress of the computations for the one or more first layers and use this indication to sequence requests for groups or batches of weights from the DSD.

In block 508, the one or more processors of the host device request a second group or next group of weights from the DSD for processing one or more subsequent layers of the neural network before computations complete for the one or more first layers or currently processing layers. Depending on the processing capability and resources available for processing the neural network, the time for performing the computations of the first layer or layers may vary. In some implementations, the NN engine may indicate to the NN layer control module, for example, when half the computations for the one or more first layers have been completed since the NN engine can know in advance the total number of computations for each layer. In other implementations, the NN layer control module may wait a predetermined amount of time after computations begin before requesting the second or next group of weights based on previous iterations of executing the neural network. In yet other implementations, the NN layer control module may monitor resources, such as memory usage by the NN engine as noted above to track the progress of the computations for the one or more first layers or a currently executing layer, or may request the second or next group of weights in response to another memory and/or processing resource becoming available.

In block 510, the host device receives the second or next group of weights from the DSD that was requested in block 508. The second or next group of weights is loaded into the at least one memory of the host device to be accessed by the NN execution engine to perform computations for the one or more subsequent layers of the neural network.

In block 512, the one or more processors of the host device initiate computations of the one or more subsequent layers of the neural network using weights from the second or next group loaded into the at least one memory in block 510. The one or more processors can invalidate or erase the data for the weights in memory or otherwise release the memory storing the weights for the one or more subsequent layers after completing the processing to free up memory in the host device. In some implementations, the NN layer control module may monitor the freeing of the at least one memory in tracking the progress of the computations for the one or more subsequent layers.

In block 514, the one or more processors of the host device determine whether there are more layers for the host device to process. In some implementations, the host device may be responsible for processing all the layers of the neural network. In other implementations, the host device may only be responsible for processing a subset of all the layers of the neural network. The host device may have a predetermined number of layers to process that may be used in block 514 to compare against a currently processed layer to determine if there are additional layers to process that require retrieving a next group of weights from the DSD. If it is determined in block 514 that there are weights for at least one additional layer to be retrieved from the DSD, the process of FIG. 5 returns to block 508 to request the next group of weights for the at least one additional layer before computations complete for a layer or layers that are currently being processed by the host device.

On the other hand, if it is determined in block 514 that there are no additional layers to be processed by the host device, the weight loading process of FIG. 5 ends in block 516. As noted above, the host device in some implementations may only compute or execute certain layers of the neural network. In cases where the host device begins with processing a layer that is not the input layer or an initial layer of the neural network, the first group of weights for the one or more first layers of the neural network referred to in block 502 can still be loaded or retrieved from the DSD faster than the second or next group of weights to reduce the overall processing time of the host device of its assigned layers because a group of weights for one or more subsequent layers processed by the host device can be requested while processing of the first layer(s) is underway by the host device.

Those of ordinary skill in the art will appreciate with reference to the present disclosure that other implementations of the weight retrieval process of FIG. 5 may differ. For example, other implementations of the weight retrieval process may include requesting groups of weights from different DSDs.

As noted above, requesting weights for a layer at a time or for groups of layers at a time while computations are performed for a current layer of the neural network can improve the processing time for the neural network by reducing the delay that would otherwise occur in waiting for all the weights to be initially loaded into the memory of the host device. This advantage is especially apparent for larger neural networks with numerous layers. In addition, with numerous layers, the loading of weights for the neural network in batches or groups corresponding to the layers of the neural network can conserve or reduce the amount of memory needed by the host device while processing the neural network since the weights can be loaded into memory from the DSD on an as-needed basis.

In this regard, requesting weights in groups can also reduce the impact of error handling that may occur in retrieving the weights, such as from read errors. In conventional systems that load all the weights for the neural network before beginning processing, any error handling typically delays the beginning of processing by the neural network. In contrast, retrieving weights in groups can facilitate error handling for a second group of weights, while neural network processing continues on an earlier layer, thereby reducing or avoiding downtime due to error handling.

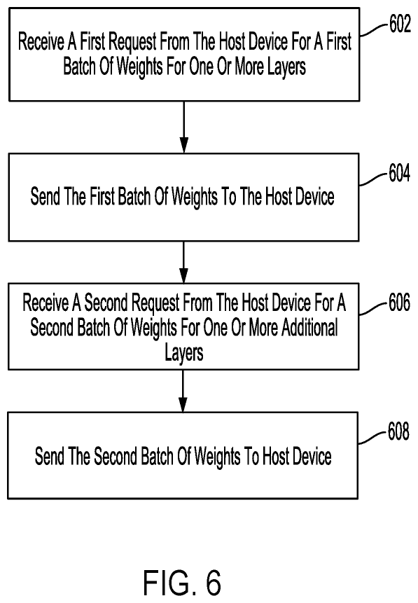

FIG. 6 is a flowchart for a batched weight access process according to one or more embodiments. The process of FIG. 6 can be performed by, for example, one or more controllers 114 of DSD 110 in FIG. 1 executing NN storage module 14.

In block 602, one or more controllers of a DSD (e.g., controller(s) 114 in FIG. 1) receive a first request from a host device (e.g., host device 102 in FIG. 1) for a first batch of weights for one or more layers of a neural network. In some implementations, a NN layer control module of the host device may interface with a NN storage module of the DSD to provide an indication of, for example, one or more layer indications for the weights of the first batch, such as by requesting the weights of layers 0 and 1. As used herein, a batch of weights can refer to weights for one or more consecutive layers of a neural network.

In block 604, the DSD sends the first batch of weights to the host device. The storage locations of the weights to be retrieved may be identified by the NN storage module of the DSD using a mapping table (e.g., mapping table 16 in FIG. 2A) or a KVS (e.g., KVS 28 in FIG. 2B). In other implementations, the host device may instead provide a starting LBA or a range of LBAs for the weights of the one or more first layers corresponding to the first batch. In the example of FIG. 1, the first batch of weights can correspond to first layer(s) weights 24 that can be retrieved faster from the DSD than additional layer(s) weights 26 due to differences in, for example, the storage media type used to store first layer(s) weights 24 and/or storage techniques used in storing first layer(s) weights 24, as compared to the storage media type and/or storage techniques used to stored additional layer(s) weights 26.

In block 606, the one or more controllers of the DSD receive a second request from the host device for a second batch of weights for one or more additional layers. As with the first batch of weights, the storage locations for the second batch of weights may be identified by a NN storage module of the DSD using a mapping table, KVS, or one or more LBAs associated with the weights of the one or more additional layers corresponding to the second batch. In the example of FIG. 1, the second batch of weights can correspond to additional layer(s) weights 26 that may be retrieved less quickly from the DSD than first layer(s) weights 24 due to differences in, for example, the storage media type used to store additional layer(s) weights 26 and/or storage techniques used in storing additional layer(s) weights 26.

In block 608, the DSD sends the second batch of weights to the host device for processing one or more additional layers of the neural network. As discussed above with reference to the neural network computation process of FIG. 5, the overall processing time for the neural network may be decreased by sending the weights for different layers in batches so the batches of weights after the first batch can be loaded into a memory of the host device while computations are performed for a current layer of the neural network.

Those of ordinary skill in the art will appreciate with reference to the present disclosure that other implementations of the batched weight access process of FIG. 6 may differ. For example, other implementations of the batched weight access process may include more than two batches of weights so that the process of FIG. 6 may repeat until there are no more batches of weights to be sent to the host device.

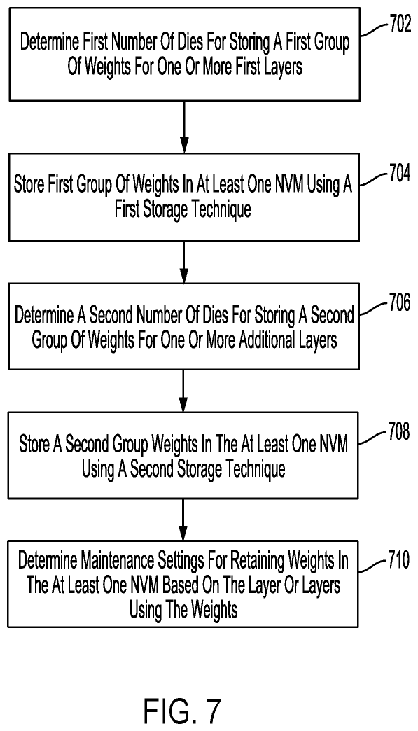

FIG. 7 is a flowchart for a weight storage process according to one or more embodiments. The weight storage process of FIG. 7 can be performed by, for example, one or more controllers 114 of DSD 110 in FIG. 1 executing NN storage module 14.

In block 702, one or more controllers of the DSD determine a first number of dies of a solid-state memory for storing a first group of weights for one or more first layers of the neural network. The first group of weights is used for computations of one or more first layers of the neural network. The determination of the number of dies may consider whether a total storage size of the weights for the first group is greater than a threshold size for a metablock, such as a metablock size discussed above with reference to FIG. 3 that can include a fixed portion or block size stored across four physical dies. In some cases, the threshold size for a metablock may be smaller for a first group of weights for one or more first layers than for a later group of weights for one or more additional layers of the neural network to provide faster retrieval of the weights in the first group by spreading the weights across more physical dies. In some implementations, the threshold size used for a metablock for a particular layer or group of weights may be set in a data structure used by the controller(s), such as in storage characteristics 18 in FIG. 1.

In block 704, the DSD stores the first group of weights in at least one NVM of the DSD using a first storage technique. The first storage technique can include, for example, an amount of parity data added for storing a particular amount of data, a programming or write speed for storing data, a number of levels (e.g., a write resolution) or number of bits to store per cell for the weights, and/or a data size or value type (e.g., a binary value type or a floating point value type) for each weight. The first storage technique can be used to reduce the latency in retrieving the first group of weights from the DSD. In some implementations, the storage technique used for storing a particular layer or group of weights may be set in a data structure used by the controller(s), such as in storage characteristics 18 in FIG. 1.

In block 706, one or more controllers of the DSD determine a second number of dies of a solid-state memory for storing a second group of weights for one or more additional layers of the neural network. The second group of weights is used for computations of one or more additional layers of the neural network that follow the one or more first layers. The determination of the number of dies may consider whether a total storage size of the weights for the second group is greater than a threshold size for a metablock that can include a fixed portion or block size stored across a predetermined number of physical dies for the metablock. In some cases, the threshold size for a metablock storing the second group may be larger than a threshold size for the first group of weights to use less physical dies in storing the weights of the second group.

In block 708, the DSD stores the second group of weights in at least one NVM of the DSD using a second storage technique that is different from the first storage technique. The second storage technique can include, for example, a different amount of parity data for storing the weights of the second group, a different programming or write speed for storing the weights of the second group, a different number of levels or bits to store per cell for the weights of the second group, and/or a different data size or value type (e.g., a binary value type or a floating point value type) for the weights of the second group. The second storage technique can be used, for example, to increase a storage density and/or decrease a storage cost (e.g., reduced power, less processing resource utilization, or less expensive storage media) for storing the second group of weights as compared to storing the first group of weights.

In some implementations, the increased storage density and/or reduced storage cost may result in a greater latency in retrieving the second group of weights from the DSD as compared to retrieving the first group of weights. However, this performance penalty may not affect the overall performance of the neural network since the weights for the neural network can be retrieved from the DSD in batches or groups as discussed above so that the batches or groups with a greater read latency are retrieved while computations are already being performed for a previous or current layer.

In block 710, the one or more controllers of the DSD determine maintenance settings for the different groups of weights stored in the NVM(s) of the DSD based on the layer or layers of the neural network that use the weights. The different maintenance settings can include, for example, using different power levels to retain weights, a frequency for read threshold calibrations for the weights, and/or a frequency of rewriting the weights. As discussed above, the different maintenance settings for the different groups can be kept or updated in a data structure used by the one or more controllers, such as in storage characteristics 18 in FIG. 1.

Those of ordinary skill in the art will appreciate with reference to the present disclosure that other implementations of the weight storage process of FIG. 7 may differ. For example, other implementations of the weight storage process may not include block 710 if the maintenance settings or maintenance operations for the different groups of weights do not vary. As another example, the weight storage process of FIG. 7 may be performed for more than two groups of weights, such as by performing blocks 706 to 710 for a third group of weights that may use the same or different number of dies as the second group, the same or different storage techniques as the second group, or the same or different maintenance settings as the second group.

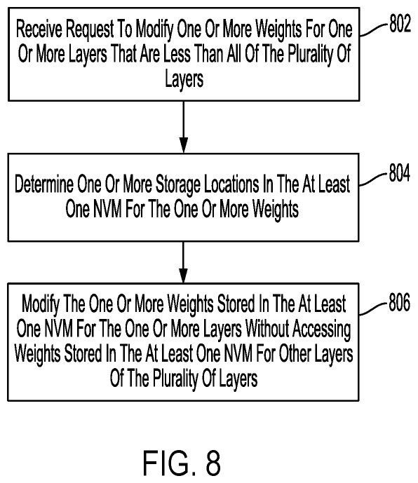

FIG. 8 is a flowchart for a weight modification process according to one or more embodiments. The weight modification process of FIG. 8 can be performed by, for example, one or more controllers 114 of DSD 110 in FIG. 1 executing NN storage module 14.

In block 802, the one or more controllers receive a request, such as a write request, to modify one or more weights for one or more layers that are less than all of a plurality of layers of weights stored in at least one NVM of the DSD (e.g., NVM(s) 116 in FIG. 1). The request may be received from a host device that executes the one or more layers of the neural network (e.g., host device 102) or from another device that may be responsible for retraining the neural network. As noted above, a device that retrains the neural network may not have access to the logical identifiers (e.g., LBAs) used by the host device that executes the neural network. In such cases, the modification or write request from the retraining device may specify the one or more layer numbers with new values to overwrite for the one or more weights and may in some implementations also include unmodified weight values for the one or more layers to be rewritten in the at least one NVM. In other cases, such as when the request comes from the host device that executes the one or more layers, the request may specify particular logical identifiers for the one or more weights with new values to overwrite only the one or more weights to be modified.

In block 804, the one or more controllers of the DSD determine one or more storage locations in the at least one NVM that store the one or more weights to be modified. In some implementations, the one or more controllers may access a mapping table (e.g., mapping table 16 in FIG. 2A) or other data structure to determine PBAs for the weights to be modified using one or more logical identifiers for the weights or using one or more layer numbers for the weights. In other implementations, the one or more controllers may use a layer number received in the request as a key in a KVS (e.g., KVS 28 in FIG. 2B) to identify the one or more weights to be modified.

In block 806, the one or more weights stored in the at least one NVM are modified for the one or more layers without accessing weights stored in the at least one NVM for other layers of the plurality of layers. The identification of storage locations for weights belonging to particular layers can ordinarily reduce the amount of data that needs to be accessed from the at least one NVM when only modifying the weights for certain layers. In contrast, DSDs that do not identify the storage locations of weights by layer may need to access much larger amounts of data or may need to overwrite larger amounts of data to make changes to weights that are only used by one layer or a few layers.

Those of ordinary skill in the art will appreciate with reference to the present disclosure that other implementations of the weight modification process of FIG. 8 may differ. For example, other implementations may include receiving multiple requests for individual weights to be modified in block 802. As another example variation, the determination of storage locations in block 804 and the modification of the weights in block 806 may overlap in time as more requests are received in block 802 for additional weights.

The foregoing storage systems for neural network weights can improve the processing times of neural networks by facilitating the retrieval of weights in batches or groups corresponding to the order of the layers in the neural network. The different treatment of weights based on the layer or layers that use the weights can provide for a more efficient and/or cost-effective storage of the weights by using different types of storage media, different storage techniques, and/or different maintenance settings for the different layers or groups of layers. In addition, the usage of the host device's memory can also be conserved by loading the weights from the DSD in batches or groups, as opposed to loading all of the weights for all the layers at one time.

### Other Embodiments

Those of ordinary skill in the art will appreciate that the various illustrative logical blocks, modules, and processes described in connection with the examples disclosed herein may be implemented as electronic hardware, computer software, or combinations of both. Furthermore, the foregoing processes can be embodied on a computer readable medium which causes processor or controller circuitry to perform or execute certain functions.

To clearly illustrate this interchangeability of hardware and software, various illustrative components, blocks, and modules have been described above generally in terms of their functionality. Whether such functionality is implemented as hardware or software depends upon the particular application and design constraints imposed on the overall system. Those of ordinary skill in the art may implement the described functionality in varying ways for each particular application, but such implementation decisions should not be interpreted as causing a departure from the scope of the present disclosure.

The various illustrative logical blocks, units, modules, processor circuitry, and controller circuitry described in connection with the examples disclosed herein may be implemented or performed with a general purpose processor, a GPU, a DSP, an ASIC, an FPGA or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. Processor or controller circuitry may also be implemented as a combination of computing devices, e.g., a combination of a DSP and a microprocessor, a plurality of microprocessors, an SoC, one or more microprocessors in conjunction with a DSP core, or any other such configuration.

The activities of a method or process described in connection with the examples disclosed herein may be embodied directly in hardware, in a software module executed by processor or controller circuitry, or in a combination of the two. The steps of the method or algorithm may also be performed in an alternate order from those provided in the examples. A software module may reside in RAM memory, flash memory, ROM memory, EPROM memory, EEPROM memory, registers, hard disk, a removable media, an optical media, or any other form of storage medium known in the art. An exemplary storage medium is coupled to processor or controller circuitry such that the processor or controller circuitry can read information from, and write information to, the storage medium. In the alternative, the storage medium may be integral to processor or controller circuitry. The processor or controller circuitry and the storage medium may reside in an ASIC or an SoC.

The foregoing description of the disclosed example embodiments is provided to enable any person of ordinary skill in the art to make or use the embodiments in the present disclosure. Various modifications to these examples will be readily apparent to those of ordinary skill in the art, and the principles disclosed herein may be applied to other examples without departing from the spirit or scope of the present disclosure. The described embodiments are to be considered in all respects only as illustrative and not restrictive. In addition, the use of language in the form of “at least one of A and B” in the following claims should be understood to mean “only A, only B, or both A and B.”

What is claimed is:

1. A Data Storage Device (DSD), comprising:
an interface configured to communicate with a host device;
at least one Non-Volatile Memory (NVM) configured to store weights for a plurality of layers of a neural network executed at least in part by the host device; and
one or more controllers, individually or in combination, configured to:
receive the weights for the plurality of layers with layer information associating the received weights with one or more layers of the plurality of layers; and
store the received weights in the at least one NVM using different storage characteristics based at least in part on the received layer information, wherein the different storage characteristics include at least one of different storage locations, different storage techniques, and different maintenance settings for retaining the weights in the at least one NVM.

2. The DSD of claim 1, wherein the at least one NVM includes a first type of storage media and a second type of storage media, the first storage media having a lower read latency than the second type of storage media; and wherein the one or more controllers, individually or in combination, are further configured to:
store a first group of weights for one or more first layers of the plurality of layers in the first type of storage media; and
store at least one other group of weights for at least one other layer of the plurality of layers in the second type of storage media.

3. The DSD of claim 1, wherein the one or more controllers, individually or in combination, are further configured to store a logical to physical mapping associating logical identifiers for the weights of the plurality of layers with their storage locations in the at least one NVM, and wherein the logical to physical mapping further includes at least one indicator for weights of a particular layer.

4. The DSD of claim 1, wherein the one or more controllers, individually or in combination, are configured to store weights for a particular layer of the plurality of layers across multiple dies of the at least one NVM to reduce a read latency for the weights of the particular layer.

5. The DSD of claim 1, wherein the one or more controllers, individually or in combination, are configured to:
determine a first number of dies of the at least one NVM for storing a first group of weights for one or more first layers of the plurality of layers based on a first storage size of the first group of weights; and
determine a second number of dies of the at least one NVM for storing a second group of weights for one or more additional layers of the plurality of layers based on a second storage size of the second group of weights.

6. The DSD of claim 1, wherein the one or more controllers, individually or in combination, are configured to:
receive a first request from the host device via the interface for a first batch of weights for one or more layers of the plurality of layers;
send the first batch of weights to the host device via the interface;
receive a second request from the host device via the interface for a second batch of weights for one or more additional layers of the plurality of layers; and
send the second batch of weights to the host device via the interface.

7. The DSD of claim 1, wherein the one or more controllers, individually or in combination, are configured to:
receive a request to modify one or more weights for one or more layers that are less than all of the plurality of layers;
determine one or more storage locations in the at least one NVM for the one or more weights; and
modify the one or more weights stored in the at least one NVM for the one or more layers without accessing weights stored in the at least one NVM for other layers of the plurality of layers.

8. The DSD of claim 1, wherein the one or more controllers, individually or in combination, are configured to:
store a first group of weights in the at least one NVM for one or more first layers of the plurality of layers using a first storage technique; and
store a second group of weights in the at least one NVM for one or more additional layers of the plurality of layers using a second storage technique, wherein the first storage technique differs from the second storage technique in at least one of how many bits are stored per cell in the at least one NVM, an amount of parity data used to store a predetermined amount of data, a write speed in storing the weights, and a data size for each weight.

9. The DSD of claim 1, wherein the different maintenance settings for retaining weights in the at least one NVM includes at least one of different power levels for different layers, different frequencies of read threshold calibration for different layers, and different frequencies of rewriting data for different layers.

10. A method for loading weights for a neural network into at least one memory, the method comprising:
requesting a first group of weights from a Data Storage Device (DSD) for one or more first layers of the neural network;
receiving the first group of weights from the DSD;
loading the first group of weights into the at least one memory;
initiating computations of the one or more first layers of the neural network using weights from the first group of weights loaded into the at least one memory; and
requesting a second group of weights from the DSD for processing one or more additional layers of the neural network before computations complete for the one or more first layers of the neural network.

11. The method of claim 10, wherein the first group of weights is retrieved from the DSD quicker than the second group of weights due to different storage characteristics for the first group of weights and the second group of weights.

12. The method of claim 10, further comprising setting different storage characteristics for storing different groups of weights in the DSD based at least in part on the layer or layers of the neural network that use the weights.

13. The method of claim 10, further comprising storing a logical to physical mapping associating logical identifiers for the weights of the neural network with their storage locations in the DSD, wherein the logical to physical mapping further includes at least one indicator for weights of a particular layer.

14. The method of claim 10, further comprising storing weights for a particular layer of the neural network across multiple dies of at least one Non-Volatile Memory (NVM) of the DSD to reduce a read latency for the weights of the particular layer.

15. The method of claim 10, further comprising:
determining a first number of dies of at least one Non-Volatile Memory (NVM) of the DSD for storing the first group of weights based on a first storage size of the first group of weights; and
determining a second number of dies of the at least one NVM of the DSD for storing the second group of weights based on a second storage size of the second group of weights.

16. The method of claim 10, wherein the DSD stores weights in at least one Non-Volatile Memory (NVM) of the DSD for a plurality layers of the neural network, and wherein the method further comprises:
receiving a request to modify one or more weights for one or more layers that are less than all of the layers of the plurality of layers;
determining one or more storage locations in the at least one NVM for the one or more weights; and
modifying the one or more weights stored in the at least one NVM for the one or more layers without accessing weights stored in the at least one NVM for other layers of the plurality of layers.

17. The method of claim 10, further comprising:
storing the first group of weights in the DSD using a first storage technique; and
storing the second group of weights in the DSD using a second storage technique, wherein the first storage technique differs from the second storage technique in at least one of how many bits are stored per cell in at least one Non-Volatile Memory (NVM) of the DSD, an amount of parity data used to store a predetermined amount of data, a write speed in storing each weight, and a data size for each weight.

18. The method of claim 10, further comprising determining maintenance settings for retaining weights in the DSD based on the layer or layers using the weights.

19. A host device, comprising:
an interface configured to communicate with a Data Storage Device (DSD) storing weights for a neural network executed at least in part by the host device;
at least one memory; and
means for:
requesting a first group of weights from the DSD for one or more first layers of the neural network;
receiving the first group of weights from the DSD;
loading the first group of weights into the at least one memory;
initiating computations of the one or more first layers of the neural network using weights from the first group of weights loaded into the at least one memory; and
requesting a second group of weights from the DSD for processing one or more additional layers of the neural network before computations complete for the one or more first layers of the neural network.

20. The host device of claim 19, wherein the first group of weights is retrieved from the DSD quicker than the second group of weights due to different storage characteristics for the first group of weights and the second group of weights.
